(19) United States
(12) Patent Application Publication
(10) Pub. No.: US 2008/0106026 A1
(43) Pub. Date: May 8, 2008

(54) Transfer Drum for Conveying a Sheet

(75) Inventors: Olaf Lorenz, Ludwigshafen (DE); Daniel Conzelmann, Dielheim (DE); Peter Hachmann, Dossenheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 11/935,643

(22) Filed: Nov. 6, 2007

(30) Foreign Application Priority Data
Nov. 6, 2006 (DE) DE 102006052127.7

(51) Int. Cl. B41F 21/10; B65H 5/12

(52) U.S. Cl. 271/3.21; 271/3.24

(57) ABSTRACT

A transfer drum for conveying a sheet has an outer contour which can be set within a turning apparatus as a function of a setting of a turning operation. A flexible plate forms an outer contour of the drum which acts for sheet guidance. The plate is connected to a drum body through at least one joint, and an apparatus for adjusting a relative position acts at ends of the plate. The ends lie in such a way that they face a gripper system.

### CROSS-REFERENCE TO RELATED APPLICATION

This application claims the priority, under 35 U.S.C. § 119, of German Patent Application DE 10 2006 052 127.7, filed Nov. 6, 2006; the prior application is herewith incorporated by reference in its entirety.

### BACKGROUND OF THE INVENTION

### Field of the Invention

The invention relates to a transfer drum for conveying a sheet. The transfer drum has a circulating drum body, a gripper system on the drum body for holding the sheet at one sheet edge, a flexible plate which forms an outer contour of the drum that acts for sheet guidance, and an apparatus for adjusting a radial position of the plate.

A transfer drum of a sheet-fed printing press includes a drum body which is mounted in side walls by way of journals. At least one gripper system for holding a sheet at the leading sheet edge is disposed on the drum body. The gripper system includes a multiplicity of individual grippers which are disposed on a pivotable gripper shaft. The gripper shaft lies parallel to the rotational axis of the transfer drum. In a turning drum which is provided specifically for turning sheets, the individual grippers are configured as tongs-type grippers. The tongs-type grippers accept the sheet from a gripper system of a storage drum which is disposed ahead of them and transfer the sheet to a gripper system of an impression cylinder. The acceptance and transfer take place in each case at the sheet edge along a gripper closing line. The gripper closing lines lie in a circumferential contour of the turning drum. The circumferential contour has the shape of a cylinder shell. The drum body and attachments which are fastened thereto, such as gripper systems and guide plates, form an aerodynamic outer contour which acts for sheet guidance.

A turning apparatus according to German Published, Non-Prosecuted Patent Application DE 199 49 412 A1, corresponding to U.S. Pat. Nos. 6,722,276 and 7,207,265, includes a turning drum having a fixed outer contour. Air can be blown out from the interior of the turning drum in order to improve release of a sheet from a storage drum which is disposed ahead of it. The air passes through a channel which is formed in the region of a tongs-type gripper system. The tongs-type grippers perform a pivoting movement during one revolution of the turning drum, for which purpose corresponding clearances are provided.

German Published, Non-Prosecuted Patent Application DE 103 55 045 A1, corresponding to U.S. Patent Application Publication No. US 2004/0135312, describes a drum having a variable outer contour. In order to adjust the outer contour to the flexural rigidity of sheets which are to be conveyed, flexurally elastic shell plates are disposed pivotably on the drum bodies. In a first operating type, the shell plates are set to an outer contour in the shape of the cylinder shell for conveying thin sheets. If paperboard sheets are to be conveyed in a second operating type, the shell plates are moved to the inside by way of a tilting tensioning unit, with the result that the outer contour has an oval profile. The pivoting axis of the sheet plates lies in each case in the vicinity of a gripper system which holds the sheet at the front edge.

A sheet guiding drum which is described in German Published, Non-Prosecuted Patent Application DE 195 11 341 A1, corresponding to European Patent No. 07 34 858 B1, has an adjustable circumferential surface. A shell plate is pulled onto a drum body for that purpose. The shell plate can be adjusted radially in a circumferential section by way of a segment piece. One end of the shell plate is fixed on the drum body, whereas the other end is held resiliently on the drum body with the force of a spring. It is therefore possible to adapt the outer contour of the drum to the sheet thickness, with the result that the unwinding speed of the sheet is adapted to the circumferential speed of an impression cylinder which is disposed in front of it. The radial adjustment of the segment piece from the interior of the drum is complicated in structural terms.

### SUMMARY OF THE INVENTION

It is accordingly an object of the invention to provide a transfer drum for conveying a sheet, which overcomes the hereinafore-mentioned disadvantages of the heretofore-known devices of this general type and which has an outer contour that can be set within a turning apparatus as a function of a setting of a turning operation.

With the foregoing and other objects in view there is provided, in accordance with the invention, a transfer drum for conveying a sheet. The transfer drum comprises a circulating drum body, a gripper system on the drum body for holding the sheet at one sheet edge, and a flexible plate forming an outer contour of the drum for sheet guidance. The flexible plate has ends facing the gripper system. At least one joint connects the flexible plate to the drum body. An apparatus acts at the ends of the flexible plate for adjusting a radial position of the flexible plate.

According to the invention, a flexible plate which forms an outer contour that acts for sheet guidance is connected to a drum body through at least one joint. An apparatus for adjusting the radial position acts at those ends of the plate which lie in the circumferential direction, with the ends lying in such a way that they face a gripper system which is fastened to the drum body. In all cases, the outer contour of the plate lies within the circumferential contour which the gripper closing line of the grippers of the gripper system describes when the transfer drum rotates.

In accordance with another feature of the invention which provides a simple construction, the plate is fixed on the drum body in a region opposite the gripper system and the apparatus which acts at the ends of the plate includes elements which can be displaced and/or pivoted tangentially.

In accordance with a further feature of the invention, the plate can be connected to the drum body by way of levers which can be pivoted in the manner of a parallelogram in such a way that an outer contour in the shape of a cylinder shell results in the extended and retracted state. In this variant, the plate can be fixed opposite the gripper system on a support which can be displaced in the radial direction.

Other features which are considered as characteristic for the invention are set forth in the appended claims.

Although the invention is illustrated and described herein as embodied in a transfer drum for conveying a sheet, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, end-elevational view of a turning drum having a shell plate which is fixed to a drum body; and

FIG. 2 is an end-elevational view of a turning drum having a shell plate which can be adjusted through a lever mechanism.

### DETAILED DESCRIPTION OF THE INVENTION

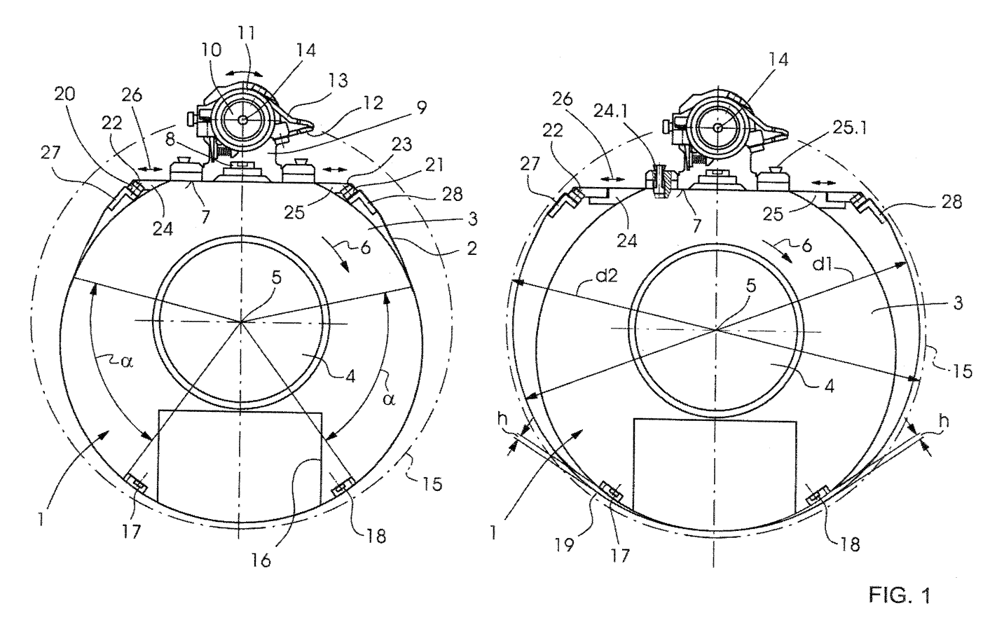

Referring now to the figures of the drawings in detail and first, particularly, to FIG. 1 thereof, there is seen a turning drum 1 having a shell plate 2 in a withdrawn and in an advanced position. The turning drum 1 includes a drum body 3, on which shaft journals 4 are formed. The turning drum 1 is mounted by way of the shaft journals 4 in side walls of a sheet-fed printing press, in such a way that it can rotate about a shaft 5 in the direction of an arrow 6. The drum body has a planar flattened section 7 which lies parallel to the shaft 5. A gripper bar 9 is fastened on the flattened section 7 by way of screws 8. The gripper bar includes bearings for a gripper shaft 10 and a gripper tube 11. The gripper shaft 10 and the gripper tube 11 are disposed coaxially with respect to one another and parallel to the shaft 5. The gripper shaft 10 and the gripper tube 11 carry a multiplicity of tongs-type gripper fingers 12, 13 for holding a sheet at the sheet edge. The gripper shaft 10 and the gripper tube 11 are coupled to mechanisms which make opening and closing of the gripper fingers 12, 13 possible and as well as a pivoting movement about a common shaft 14 during a revolution of the turning drum 1. During the revolution of the turning drum 1, the shaft 14 lies on a circumferential contour 15 in the shape of a cylinder shell.

The drum body 3 has an eccentric profile and lies within the circumferential contour 15. A channel 16, which lies parallel to the shaft 5 in the longitudinal direction, is formed in the drum body 3, on the side which lies opposite the gripper bar 9. The shell plate 2 is fixed by way of screws 17, 18 in the vicinity of the channel 16, with the shell plate 2 bridging the channel 16 in an arcuate manner. The shell plate 2 is spanned by a cover 19 which repels printing ink. Ends 20, 21 of the shell plate 2 are each clamped on a respective slide 24, 25 by way of a respective screw 22, 23. The slides 24, 25 can be moved in a rectilinear guide in a tangential direction 26, manually or by way of an actuator, and can be fixed in two end positions by way of clamping devices 24.1, 25.1.

If the slides 24, 25 are pulled in, the ends 20, 21 of the shell plate 2 lie close to the surface of the drum body 3. The shell plate 2 bears against the outer contour of the eccentric drum body 3 over a large angle of rotation range α. Sheets which are printed only on one side are conveyed in this position of the shell plate 2.

If printing is to be carried out on both sides of the sheet with the sheet-fed printing press, the turning drum is set up for turning operation. To this end, inter alia, the slides 24, 25 are moved into a second end position, with the result that the ends 20, 21 lie close to the circumferential contour 15. The active outer contour of the cover 19 is then in the shape of the cylinder shell having a diameter d1 which is somewhat smaller than the diameter d2 of the circumferential contour 15. In the fixing region of the shell plate 2 on the drum body 3, the cover 19 is raised up from the shell plate 2 by an amount h. The ends 20, 21 of the shell plate 2 are clamped at the ends of the slides 24, 25 by way of L-shaped carrier strips 27, 28. The shell plate 2 is subjected to a flexural load in each case at the long limb of the carrier strip 27, 28. The shell plate 2 is composed of a spring steel, the flexural rigidity of which ensures the dimensional stability of the shell plate 2 during the revolution of the turning drum 1.

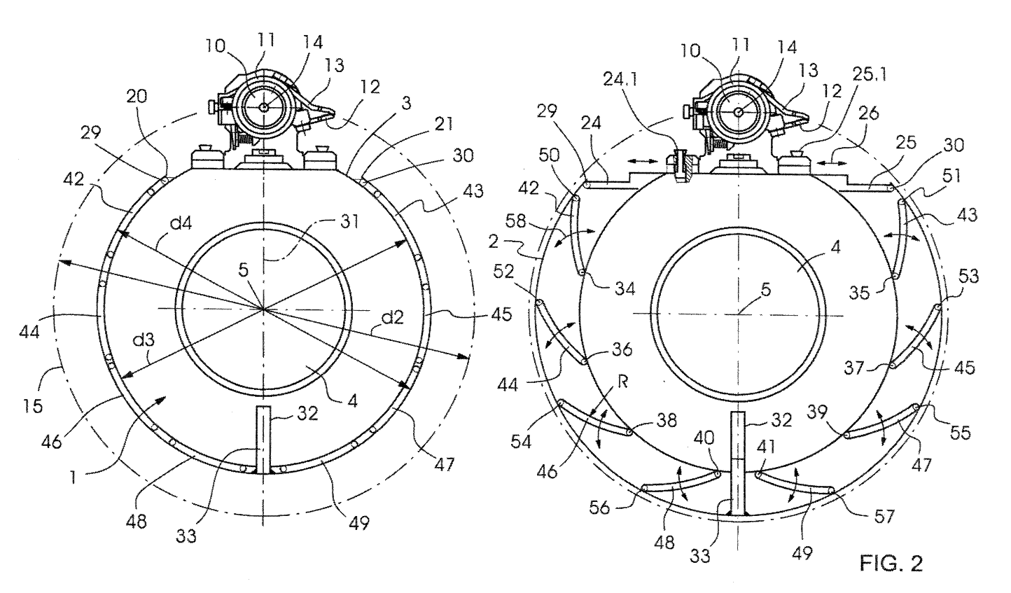

In a variant according to FIG. 2, a drum body 3 of a turning drum 1 has an outer contour in the shape of the cylinder shell. At the ends 20, 21, the shell plate 2 is connected to rotary joints 29, 30 by way of slides 24, 25 which can move in a rectilinear guide in the tangential direction 26. The rotary joints 29, 30 lie symmetrically with respect to a plane 31, in which the rotational shaft 5 of the drum body 3 and the pivot shaft 14 of the tongs-type grippers 12, 13 lie. A rectilinear guide 32 for a support 33 is provided on the drum body 3, diametrically opposite the gripper shaft 10 and the gripper tube 11. The shell plate 2 is fixed on the support 33. Rotary joints 34-41 for arcuate levers 42-49 are provided on the drum body 3 symmetrically with respect to the plane 31. The levers 42-49 are disposed in the manner of a parallelogram and end at rotary joints 50-57 on the underside of the shell plate 2. A bending radius R of the levers 42-49 is adapted to a diameter d3 of the drum body 3.

In order to transport sheets in recto printing operation, the slides 24, 25 are retracted and fixed in such a way that the levers 42-49 bear against the outer contour of the drum body 3. The shell plate 2 lies on a diameter d4 considerably below the diameter d2 of the circumferential contour 15 of the gripper shaft 10 and of the gripper tube 11. In verso printing operation, the slides 24, 25 are extended and fixed in such a way that the shell plate 2 lies close to the circumferential contour 15. During extension of the slides 24, 25, the levers 42-49 synchronously perform pivoting movements 58 in each case about the rotary joints 34-41 and 50-57 and the support 33 is driven along to the outside in the rectilinear guide 32. During the revolution of the turning drum 1, the levers 42-49 have a stabilizing effect on the external shape of the shell plate 2.

The invention is not restricted to the exemplary embodiments which are described. The position of the shell plate 2 can be controlled or regulated through the use of a sensor and an electric, hydraulic or pneumatic actuator. The position of the shell plate 2 can be set with the aid of mechanism elements or transmission members, such as cams, eccentrics or ramps, with the turning drum 1 rotating for setting. In particular, the position of the shell plate 2 can be set at the same time as an adjustment of other elements of a turning apparatus. For example, an axial displacement of a cam roller can be used, in order to actuate the slides 24, 25. In one embodiment without a cover 19, the shell plate 2 can be provided with a coating which repels printing ink or the surface of the shell plate 2 can be configured so as to repel printing ink.

1. A transfer drum for conveying a sheet, the transfer drum comprising:
a circulating drum body;
a gripper system on said drum body for holding the sheet at one sheet edge;
a flexible plate forming an outer contour of the drum for sheet guidance, said flexible plate having ends facing said gripper system;
at least one joint connecting said flexible plate to said drum body; and
an apparatus acting at said ends of said flexible plate for adjusting a radial position of said flexible plate.

2. The transfer drum according to claim 1, wherein said flexible plate is fixed on said drum body in a region opposite said gripper system.

3. The transfer drum according to claim 1, which further comprises parallelogram-shaped levers connecting said flexible plate to said drum body, said levers being fastened for articulation to an inner side of said flexible plate and to said drum body.

4. The transfer drum according to claim 3, which further comprises a support to be displaced in radial direction of said drum, said flexible plate being fixed opposite said gripper system on said support.

5. The transfer drum according to claim 1, which further comprises a printing ink-repelling cover disposed outside said flexible plate.

6. The transfer drum according to claim 1, wherein said apparatus includes tangentially displaceable actuators.

7. The transfer drum according to claim 6, wherein said actuators are simultaneously actuatable.

8. The transfer drum according to claim 6, wherein said actuators are rotationally fixedly attached to said ends of said flexible plate.

9. The transfer drum according to claim 1, wherein said gripper system has a circumferential contour, and said flexible plate lies within said circumferential contour of said gripper system.
